(19) United States
(12) Patent Application Publication
(10) Pub. No.: US 2002/0032609 A1
(43) Pub. Date: Mar. 14, 2002

(54) Calendar transaction manager agent, systems and methods

(76) Inventor: Michael Allen Wilkman, Alamo, CA (US)

Correspondence Address: Michael A. Wilkman, P.O. Box 546, Alamo, CA, 94507, US

(21) Appl. No.: 09/911,102

(22) Filed: Jul. 23, 2001

Related U.S. Application Data
(60) Provisional application No. 60/221,477, filed on Jul. 27, 2000.

(51) Int. Cl. G06F 17/60

(52) U.S. Cl. 705/14

(57) ABSTRACT

The present invention relates generally to systems and methods for providing transaction control through a calendar interface or time date preference for purchasing decisions that involve the use of credits, debits, loyalty points, affinity points, promotions and currency transfers. The present invention provides a common forum where merchants desiring to target consumers prior to or at the time of purchase are matched with customers who desire information, goods, or services related to the merchant. In general, the matching and coordinating of the credit accounts, debit accounts, loyalty (points) programs, affinity (points) programs, promotions and currency exchanges are performed such that consumers and businesses may obtain the greatest financial, promotional, or desired benefit on purchases of goods and services Further, merchants may present promotional opportunities to consumers or businesses prior to, at the time of or after transacting the payment of goods or services.

### PRIORITY INFORMATION

This application relates to and claims priority from Provisional Application No. 60/221,477 filed Jul. 27, 2000.

### FIELD OF THE INVENTION

The present invention relates generally to electronic commerce processing, and in particular to systems and methods for providing custom transaction control for purchasing decisions which involve credits, debits, loyalty points, affinity points, promotions and/or currency transfers in conjunction with a calendar interface.

### BACKGROUND

With the increasing popularity of the use credit accounts, debit accounts, loyalty (points) programs, affinity (points) programs, electronic promotions, and currency exchanges by individuals making purchasing decisions, purchasers and customers often desire that each purchasing decision is calculated to provide the maxim financial or targeted benefit for the purchaser. Often, the actual cost of purchasing goods or services may be greatly enhanced by knowing the combined benefit of all the accounts, programs and promotions that relate to the actual purchase. Additionally, merchants would welcome the opportunity to interact with purchasers prior to the payment process.

Customers and businesses often make decisions based on a calendar or more importantly a time and date preference. When purchasing decisions are made based on the availability presented by the purchaser's calendar, often the final purchase decision could be optimized with a variety of incentives and promotions which might be advantageously presented before, at the time of, or after the purchase transaction. One common problem, however, is that the great number of accounts and programs available to customers and businesses, who are making purchasing decisions, may not be remembered or understood at the time of purchase. Further, many of the accounts, programs and promotions are being updated constantly making it impossible for customers to remember all the possibilities and combinations that may affect the purchase. Additionally, with the rapid growth of a variety of devices for executing purchases including personal computers, cell phones, smart cards, Palm devices, kiosks, conventional telephones, as well as conventional credit cards, customers may not locate purchasing incentives and promotional opportunities which might reduce or enhance the actual purchase price. Even if customers or businesses are able to find a set of accounts, programs and/or promotions which provide the maxim desired benefit, prior to or at the time of purchase, it is often time consuming for the customer/purchaser to peruse all the opportunities which might enhance the final purchase decision.

Furthermore, even if the customer or purchaser finds one or more merchants that provide the desired interest rate, loyalty points or promotions which enhance the final purchase price, it is common that the opportunities have expired or do not apply to the customer's needs and thereby fail to apply to the particular date, product and/or place of the desired goods or services. Finally, merchants desiring to target purchasers with opportunities and incentives, at or prior to the time of purchase, are in need of a common forum to securely present, distribute and transact their purchasing incentives using a broad range of devices which may be utilized by purchasers to initiate the transaction.

### SUMMARY OF THE INVENTION

The present invention generally involves using the methodology of a calendar or time and date preference in matching and coordinating the use of credit accounts, debit accounts, loyalty (points) programs, affinity (points) programs, promotions, and currency exchanges to enhance the purchase transaction of customers and businesses. The enhancements may include financial, promotional, or other benefits for various purchases of goods and services thereby enabling merchants to target their incentives to customers and businesses prior to or at the time of the purchase transactions.

In one embodiment, the present invention is a system for facilitating the matching of at least one promotion with at least one user. The system comprises a merchant management module configured to manage at least one promotion that corresponds to at least one of a plurality of merchants, a user module configured to manage preferences, and a transaction module configured to present information about the at least one promotion to one the at least one user wherein the promotion relates to preferences that correspond to the user. The present invention involves a calendar transaction manager system which has a user customization module configured by the user to automatically execute purchases based on predetermined preferences. In a further embodiment, the user customization module is configured to present the purchasing options to the user prior to executing the purchase transaction. For example, the user may have four credit lines each with different due dates when the bill must be paid in full. The user sets the customization module to execute the purchase transaction on the credit line with the most number of days prior to the account being due and payable. The electronic device, where the user's calendar transaction manager resides, presents the information on the credit lines prior to the purchase transaction through a visual display or by audible information to the user and/or the system could be set to automatically default to the desired preferences of the user and execute the purchase transaction automatically. In this aspect, the calendar transaction manager module operates independently as an agent on behalf of the user.

An additional embodiment of the present invention is a method for managing a plurality of custom-selected promotions. The method comprises requesting a plurality of promotions relating to a plurality of merchants, submitting user information relating to at least one user, receiving a set of promotions, wherein the set corresponds to at least a subset of the user information and at least one of the plurality of merchants, and selecting one set of promotions. The present invention involves a calendar transaction manager system which has a merchant manager module configured to manage promotions from merchants and a user customization module configured to provide a user with a custom calendar transaction manager listing promotions and opportunities from the merchants. In one embodiment, the merchant management module is configured to register merchants, collect promotions, and track merchant billing information. In a further embodiment, the user customization module is further configured to process queries in order to determine the user's interests, select promotions that relate to the user's interest, and present a transaction manager that includes information on the selected promotions prior to the purchase transaction. In one embodiment, the user customization module is further configured to register a plurality of users. The user customization module may also be configured to directly present to users promotions relating to the user's interests.

Another aspect of the present invention involves a calendar transaction manager system comprising a merchant management module configured to manage promotions from merchants, and a user customization module configured to provide a user with a custom set of promotions wherein a least one of the set of promotions are from the merchants. Advantageously, the merchant management module is further configured to register merchants, collect promotions, and track merchant billing information.

Another aspect of the present invention involves a method for providing custom promotions. This method involves receiving a plurality of promotions relating to a plurality of merchants, receiving a plurality of user information relating to a plurality of users, matching at least one of the plurality promotions to the at least one of the plurality of users based al least on the plurality of users information, and presenting to the at least one of the plurality of users a promotion that includes information on the matching at least one of the plurality of promotions. In one embodiment of the method, the promotion display is an interactive coupon. In another embodiment, the promotion display is an audio and video commercial.

For summarizing the invention, certain aspects, advantages, and novel features of the invention are described herein. It is to be understood that not necessarily all such advantages may be achieved in accordance with any particular embodiment of the invention. Thus, for example, those skilled in the art will recognize that the invention may be embodied or carried out in a manner that achieves one advantage or group of advantages as taught herein without necessarily achieving other advantages as may be taught or suggested herein.

### BRIEF DESCRIPTIONS OF THE DRAWINGS

These and other features and advantages of the invention will now be described with reference to the drawings and of certain preferred embodiments, which are intended to illustrate and not limit the invention, and in which:

FIG. 1 illustrates a high-level block diagram of one embodiment of the present illustration.

FIG. 2 illustrates a flow diagram of one embodiment of registering a merchant.

FIG. 3 illustrates a flow diagram of one embodiment of collecting promotions from a merchant.

FIG. 4 illustrates a flow diagram of one embodiment of calculating the merchant's bill.

FIG. 5 illustrates a flow diagram of one embodiment of registering a user.

FIG. 6 illustrates a flow diagram of one embodiment of accepting a user request.

FIG. 7 illustrates a flow diagram of one embodiment of querying the user to determine the user's interests.

FIG. 8 illustrates an example of web page which includes one view of a sample calendar transaction manager.

FIG. 9 illustrates an example display from a sample calendar transaction manager.

FIG. 10 illustrates an example of various differential filters for the calendar transaction manager as seen on a display.

FIG. 11 illustrates an example display from a sample calendar transaction manger

FIG. 12 illustrates a block diagram of one embodiment of the calendar transaction manager acting as an independent Agent.

### DETAILED DESCRIPTION OF PREFFERED EMBODIMENTS

Systems and methods which represents one embodiment and example application of the invention will now be described with reference to the drawings. Variations to the systems and methods which represent other embodiments will also be described. In one embodiment, the systems and methods are used to provide remote users with a customized calendar transaction manager.

For purposes of illustration, one embodiment will be described in the context of the Internet. The inventors contemplate that the present invention is not limited by the type of communications medium used, and that other types of communications mediums may be used, such as, for example, satellite broadcasts, and so forth. Furthermore, in other embodiments, the calendar transaction manager systems and methods may be implemented as a single module, as a collection of modules, and/or implemented in conjunction with a variety of other modules and the like. Moreover, the specific implementations described herein are set forth in order to illustrate, and not to limit, the invention. The scope of the invention is defined by the claims.

These and other features will now be described with reference to the drawings summarized above. The drawings and the associated descriptions are provided to illustrate embodiments of the invention, and not to limit the scope of the invention. Throughout the drawings, reference numbers are re-used to indicate correspondence between referenced elements. In addition, the first digit of each reference number indicates the figure in which the element first appears.

I. Overview

Within the realm of electronic commerce, it is common for customers to purchase goods and services from a variety of remotely accessible merchants. As part of the electronic commerce experience, customers attempt to maximize or enhance their purchasing power by finding programs that provide an additional benefit to the customer. These programs may include merchant-sponsored programs such as discounts, coupons, and free goods and services. In addition, the programs may include programs sponsored by third parties such as, for example, sweepstakes, interactive games, credit card rebates, charitable donations, and so forth. These third-parties may include, for example, payment entities (e.g., credit card companies, debit card companies, on-line payment companies), as well as charitable entities, manufacturers, advertisers, and so forth.

Numerous activities are planned and executed based on calendars. To assist people in planning and executing purchases based on time and date preferences, the present invention provides an agent, system and method for providing a custom calendar transaction manager that the customer may remotely access and control. The agent, system and method of the present invention overcomes the difficulties discussed above by providing a common forum where customers and businesses can match and coordinate via a calendar interface and or time date preference the use of credit accounts, debit accounts, loyalty (points) programs, affinity (points) programs, promotions, and currency exchanges so that customers and businesses can obtain the greatest desired benefit on each and every purchase of goods and services and merchants can advertise their goods and services, customers can find promotions that apply to the goods and services they seek, and merchants can target certain promotions to a customer who has indicated an interest in the targeted area. The customer may set up rules that govern which accounts will be used to pay for various transactions based upon criteria, such as for example, date of transaction, amount of transaction, merchant, and so forth.

As used herein, the term “calendar transaction manager” refers to a software or agent that includes various types of differential filters and promotions and is not intended to imply that only transaction promotions may be displayed on the manager. Furthermore, while the system is discussed as being implemented on an Internet web site, it is recognized that invention may be implemented in standalone software program and/or encoded into hardware and embedded in a variety of systems, such as, for example, a cellular phone, a portable computing device, a computer, a smart card, and so forth. In addition, the system may be accessed using a variety of communication techniques, such as, for example, an Internet connection, a telephone line, customized email, and so forth.

In accordance with one aspect of the invention, the calendar transaction manager tracks and manages credit card accounts as indicated by the user. In accordance with another aspect of the invention the calendar transaction manager tracks and manages debit card accounts. In a further embodiment, the calendar transaction manager tracks and manages loyalty point and affinity point accounts as indicated by the user. In still another embodiment, calendar transaction manager tracks and manages currency transfers.

In accordance with another aspect of the invention, the calendar transaction manager system manages merchants and their promotions. In one embodiment, the merchant management module collects and manages information about various merchants that wish to promote goods or services on the system and allows merchants to submit promotions for display on a transaction manager or directly target advertising to customers having indicated an interest. In addition, in one embodiment, the merchant management module tracks when a merchant's promotions are displayed, sent directly to the user, and/or accessed by user.

In accordance with another aspect of the invention, the calendar transaction manager system provides the user with a custom calendar transaction manager in response to a request In one embodiment, the user customization module collects and manages information about users that wish to view a calendar transaction manager, queries the user to determine the user's interests (e.g., the user's target date, place and event), chooses promotions related to the user's designated interests, and displays promotions related to the user's designated interests on the dates indicated. It is recognized that in other embodiments the user may access coupons without using or having the transaction manager. For example, a user may be sent a targeted promotion via email based upon the user's profile.

II. Calendar Transaction Manager System

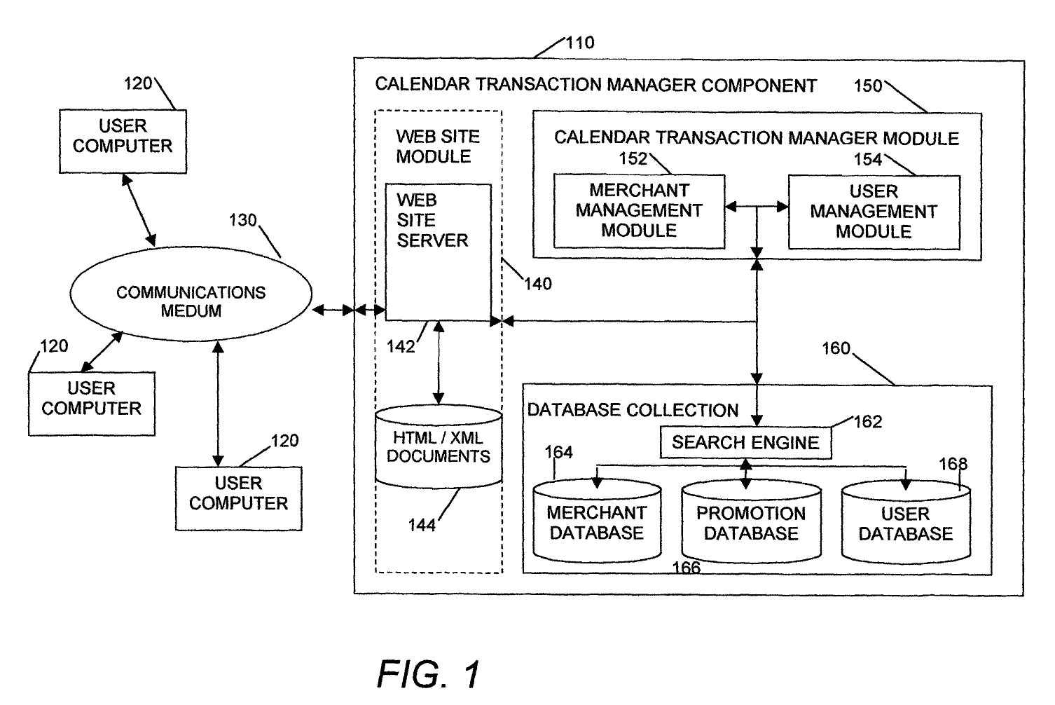

An overview of one embodiment of a calendar transaction manager system is shown in FIG. 1. In the exemplary system, a calendar transaction manager component 110 communicates with a user computer 120 over a communications medium 130. The calendar transaction manager component 110 in FIG. 1 includes a web site module 140, though it is recognized that in other embodiments, the calendar transaction manager module 150 may be implemented as a separate module and/or implemented without using a web site module.

As used herein, the word module and component, whether in upper or lower case letters, refers to logic embodied in hardware or firmware, or to a collection of software instructions, possibly having entry and exit points, written in a programming language, such as, for example, C++. A software module may be compiled and linked into an executable program, or installed in a dynamic link library, or may be written in an interpretive language such as BASIC. It will be appreciated that software modules may be callable from other modules or from themselves, and/or may be invoked in response to detected events or interrupts. Software instructions may be embedded in firmware, such as an EPROM. It will be further appreciated that hardware modules may be comprised of programmable units, such as programmable gate arrays or processors. The modules described herein are preferable implemented as software modules, but could be represented in hardware or firmware.

A. Calendar Transaction Manager Component

In one embodiment, the calendar transaction manager component 110 includes web site module 140, a calendar transaction manager module 150, and a database collection 160.

The calendar transaction manager component 110 may interact with other components, interfaces, and/or protocols (not shown). For example, the calendar transaction manager component 110 may communicate with a user's date book software to order synchronize with other transaction manager events. This synchronization may be one way or two way synchronization wherein the calendar transaction manager module 150 only receives events, only sends events, or receives and sends events. In another example, the calendar transaction manager may synchronize with a cellular phone to allow the user to receive phone calls about a variety of promotions and/or to automatically call merchants to obtain more information about the promotions. In another example, the calendar transaction manager might be set to acquire discounts in a certain location, i.e. zip code. The user might activate a GPS (global positioning) interface for the calendar transaction manager to send opportunities which match the user's interest in a specific location. By restricting selections, the calendar transaction manager may also become a filter preventing invasion of the user's privacy by unwanted advertisers.

1. Web Site Module

As illustrated by FIG. 1, the calendar transaction manager component 110 includes web site module 140 may include a web site server application (“web server”) 142 which processes user requests received from the user computers 120 via the communication medium 130. The user requests may include, for example, requests to view a calendar transaction manager, request to search on-line for promotions, and/or requests update merchant billing information. In one embodiment, the web server 142 accesses a database of HTML (Hypertext Markup Language) or XML content 144 which includes, among other things, web pages for performing various types of functions. In other embodiments, the database of HTML or XML 144 may also include other information such as server and client side scripts.

In one embodiment, the web server 142 includes web server software (not shown), such as, for example, Netscape's Internet Server software, Microsoft's Internet Server software, or the like. Such web server software may be configured to process messages from the user computers 120 and to store and access information from the calendar transaction manager component 110.

2. Calendar Transaction Manager Module

In one embodiment, the calendar transaction manager component 110 includes a calendar transaction manager module 150. The exemplary calendar transaction manager module 150 includes a merchant management module 152 and a user customization module 154.

In one embodiment, the calendar transaction manager module 150 interacts with the database collection 160 to search and perform queries on the database collection 160. For example, calendar transaction manager module 150 may communicate with the user database to obtain information regarding the user's interest, with the promotion database to select promotions that relate to the user's interest, and/or with the merchant database to obtain information about the merchants.

In one embodiment, the calendar transaction manager module 150 interacts with the web site module 140 to receive and provide promotion information, user information, and merchant information to the user computer 120.

3. Merchant Management Module

The merchant management module 152 manages the merchants and their promotions. In one embodiment, merchants are permitted to view user transaction managers and requests. For example, a merchant may enter the web site, and view the user's calendar transaction manager to decide whether to add a promotion to the database, or even to add a promotion to a specific user's calendar transaction manager. In one embodiment, the merchant management module 152 communicates with the database collection 160 to allow merchant to search user transaction managers for specific requests. Merchants may then provide a related promotion directly to a requesting user.

In one embodiment, the merchant may search user calendar transaction managers to determine the user's credit requirements based on a purchase. For example, a merchant may gauge how much credit is required for a purchase, what users may be willing to pay for the credit card useage, whether there are auction opportunities such that the merchant or user may bid for a promotion rate, what action may be taken to reduce or maximize the merchant's ability to sell a credit relationship to the user. The merchants may be given search tools as well as standard and/or customized reports that access user information.

In one embodiment, the merchant management module 152 includes a merchant registration process, a promotion collection process, and a merchant billing process. For more information on the merchant management module processes, see the section below entitled “Calendar Transaction Manager Processes-Merchant Management Module Processes.”

4. User Customization Module

The user customization module 154 manages the users and provides the users with a calendar transaction manager. For example, a user may enter the web site and request information on a an activity or purchase for a specific date. In one embodiment, the user customization module 154 communicates with the database collection 160 to find and receive user information, promotion information, and/or merchant information.

In one embodiment, the user customization module 154 includes a user registration process and a user request process. For more information on the user customization module processes, see the section below entitled “Calendar Transaction Manager Processes-User Customization Module Processes.”

B. Database Collection

In one embodiment, the calendar transaction manager system includes a database collection 160 as illustrated in FIG. 1. The exemplary database collection 160 includes a search engine 162 as well as a merchant database 164, promotion database 166, and a user database 168.

The search engine 162 is a program that searches a database using keywords and/or phrases. Thus the search engine 162 may be used to access information in the database. Many such tools are well known in the art. Thus, the search engine 162 may be used to access information in the database. In one embodiment, the search engine 162 may be implemented in connection with a backend component (not shown) to the database collection 160 that receives database requests via servlets, small programs that run on servers, and send a corresponding SQL request to the database collection 160. It is recognized that in other embodiments data access could be performed differently, for example, a different backend component could be used or the database collection 160 could be accessed directly.

The merchant database 164 includes information about the merchants that provide promotions for the calendar transaction manager system as well as merchants that want to target particular users who have interests relating to the merchant's products and/or services. This information may include data provided by the merchants such as the merchant's name, mailing address, email address, credit card number, login, password, as well as other general information.

The promotion database 166 includes information about the various promotions. In one embodiment, the promotions are related to a merchant in the merchant database 160 such that when a promotion is displayed or accessed, the merchant may be identified and billed. The promotion database 166 may include information such as text to display for the promotion, a printable coupon, accompanying graphic files, expiration dates, merchant ID, targeted user, and any other information relating to the promotion. For more information on systems and methods for providing customers with a coupon calendar, please refer to U.S. patent application Ser. No. 09/574,627 filed May 19, 2000, which is hereby incorporated by reference.

In one embodiment, promotions may be based on the UPC (uniform Price Code) prior to the purchase transaction. THE UPC Code of the product may be input through the user's device keypad, voice, or scanning receiver and may be used to store the promotion in the promotion database 166. The manufacturer of the subject product or storefront where the product is located could then interface with the user's calendar transaction manger to provide additional opportunities to induce a particular purchasing method.

The user database 168 includes information about the users of the calendar transaction manager system. This information may include user data such as name, age, sex, address, email address, planned events, login, password, as well as other information derived form the user's activity on the web, such as, the fact that the user selected four three purchases relating to golf, thus implying an interest in golf, the user's time spent on the web site, the number of click throughs and so forth.

The database collection 160 may also include other databases (not shown) for performing various management tasks. For example, the database collection 160 may include and activity database that tracks user and merchant activity. In addition, the database collection 160 may include different search mechanisms to acquire information and promotions matching the user's demands from other web sites. For example, the user desires to purchase a particular air travel from a particular airline using a particular credit card. The calendar transaction manager receives the query and looks at available web sites with promotions, credit cost price points or loyalty points that meets the user query and might be an advantage to the user. In other words, the calendar transaction manager acts as an agent of the user.

In connection with the database collection 160, in one embodiment there may be several processes (not shown) such as ID generators, number generators, statistics generators, session generators, and temporary storage units that work with the database collection 160.

In one embodiment, the database collection 160 is implemented using the relational database Microsoft® SQL Server allowing access to the data via the Structured Query Language (SQL). SQL is a language standardized by the International Standards Organization for defining, updating, and querying a relational database.

It is recognized that in other embodiments, the database collection 160 may be implemented using different relational databases as well as other types of databases such as flat file databases, an object oriented database, a hierarchical database, and so forth. Moreover, while the database collection 160 depicted in FIG. 1 is comprised of several separate databases, it is recognized that in other embodiments, the database collection 160 may contain other databases and/or some of the databases could be combined. In addition, the database collection 160 may be implemented as a single database with separate tables or as other data structures that are well known in the art such as linked lists, binary trees, and so forth.

C. User Computer

In one embodiment, the user computer 120 is a device which allows users and/or merchants to interact with the communications medium 130 and access the calendar transaction manager component 110. In one embodiment, the user computer 120 is a conventional general purpose computer using one or more microprocessors, such as, for example, as Pentium processor, a Pentium II processor, a Pentium Pro processor, an xx86 processor, 8051 processor, a MIPS processor, a Power PC processor, or an Alpha processor. In one embodiment, the user computer 120 runs an appropriate operating system such as, for example, Microsoft® Windows® 3.X, Microsoft® Windows® 98, Microsoft® Windows® NT, Microsoft® Windows® CE, Palm Pilot OS, Apple® MacOS®, Disk Operating System (DOS), UNIX, Linux®, or IBM® OS/2® operating systems. In one embodiment, the user computer 120 equipped with a conventional modem or other network connectivity such as, for example, Ethernet (IEEE 802.3), Token Ring (IEEE 802.5), Fiber Distributed Datalink Interface (FDDI) or Asynchronous Transfer Mode (ATM). As is conventional, in one embodiment, the operating system includes TCP/IP stack which handles all incoming and outgoing message traffic passed over the communications medium 130.

In other embodiments, the user computer 120 may, for example, be a computer workstation, a local area network of individual computers, and interactive television, an interactive kiosk, a personal digital assistant, an interactive wireless communications device, a kiosk, a handheld computer, a telephone, a cellular phone, a router, a satellite, a smart card, an embedded computing device, or the like which can interact with the communication medium 130. While in such systems, the operating system will differ, they will continue to provide the appropriate communications protocols needed to establish communication links with the communications medium 130.

D. Communications Medium

In one embodiment, the user computers 120 communicate with the calendar transaction manager component 110 using a communications medium 130. The communications medium 130 provides a path or link through which information can travel. The communications medium 130 may include one or more paths and may be implemented using physical links, such as, a connecting cable, and/or non-physical links such as channels that send electromagnetic transmissions via satellite, radio, microwave signals, and so forth.

In one embodiment, the communications medium 130 includes the Internet which is a global network of computing devices. The structure of the Internet, which is well known to those of ordinary skills in the art, includes a network of backbone with networks branching from the backbone. These branches, in turn, have networks branching from them, and so on. Routers move information packets between network levels, and then from network to network, until the packet reaches the neighborhood of its destination. Form the destination, the destination network's host directs the information packet to the appropriate terminal, or node. For amore detailed description of the structure and operation of the Internet, please refer to “The Internet Complete Reference,” by Harley Hahn and Rick Stout, published by McGraw-Hill, 1994.

In one embodiment, the Internet routing hubs comprise domain name system (DNS) servers, as is well known in the art. DNS is a Transfer Control Protocol/Internet Protocol (TCP/IP) service that is called upon to translate domain names to and from Internet Protocol (IP) addresses. The routing hubs connect to one or more other routing hubs via high speed communication links.

One popular part of the Internet is the World Wide Web. The World Wide Web contains different computer which store documents capable of displaying graphical and textual information. The computers which provide information on the World Wide Web are typically called “web sites.” A web site is defined by an Internet address which has an associated electronic page. The electronic page can be identified by a Uniform Resource Locator (URL). Generally, an electronic page is a document which organizes the presentation of text, graphical images, audio, video, and so forth.

One of ordinary skill in the art will recognize that a wide range of interactive communications medium 130s may be employed in the present invention. For example, the communications medium 130 may include interactive television networks, telephone networks, wireless data transmission systems, two-way cable systems, customized computer networks, interactive kiosk networks, automatic teller machine networks, and the like.

III. Calendar Transaction Manager Processes

In one embodiment, the calendar transaction manager module 150 includes several processes associates with the merchant management module 152 as well as the user customization module 154.

A. Merchant Management Module Processes

In one embodiment, the merchant management module 152 includes a merchant registration process, a promotion collection process, and a merchant billing process. The merchant management module 152 may include other processes (not shown) such as, for example, a process for sending updates to merchants, a process for tracking merchant activity, and so forth.

1. Merchant Registration Process

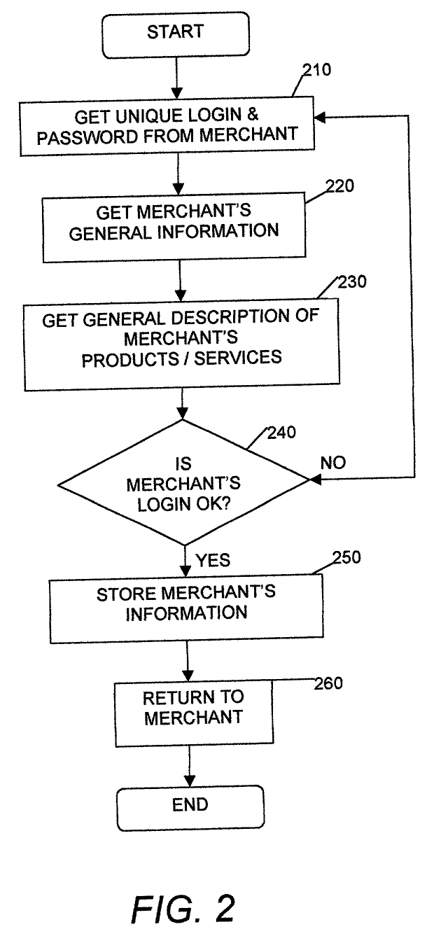

In one embodiment, the merchant registration process collects and manages information about the various merchants that wish to utilize the calendar transaction manager. It is understood that the merchant may be able to communicate directly with the calendar transaction manager agent through a communication medium. However, for illustration a preferable method might be, the merchant registration process permits merchants to submit their information on-line via the web site as illustrated in FIG. 2.

First, the merchant creates a unique login and secure password (block 210). Next, the merchant submits general information such as its name, mailing address, phone number, email address, credit card number, as well as any other general information (block 220). Third, the merchant may submit a general description of merchant's products and/or services or opportunities to co-promote with other companies offers (block 230). Then, the merchant registration process, illustrated in FIG. 2, verifies that the login is unique (block 240), stores the merchant's information (block 250), and returns to the merchant block (260).

FIG. 2 illustrates one embodiment of the merchant registration process and other embodiments may be used. For example, the merchant's login may be verified immediately after login and password are received from the merchant. Further, the merchant may submit general information and/or product/service information at a different time. Also, the merchant's information may be stored as soon as it is received from the merchant. Other variations are also possible.

It is recognized that in other embodiments, the merchant may submit information using other methods such as submission by email, filling out a paper questionnaire, faxing the information, or communicating directly to the user's device using telephony, microwave or Internet etc. In addition, in other embodiments, a single merchant may use a separate login for each type of product or service it promotes or other methods may be used to identify the merchant and its products such as creating a unique merchant identifier as well as unique product/service identifiers for each product or service.

2. Promotion Collection Process

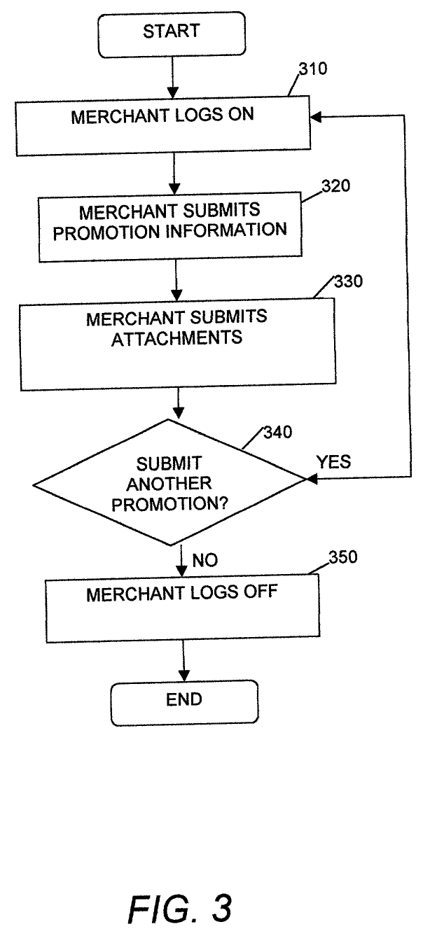

In accordance with one aspect of one embodiment of the invention, the promotion collection process allows merchants to submit promotions for display on calendar transaction managers or for direct target advertising. In one embodiment, the promotion collection process receives promotions from merchants on-line via the web site as illustrated in FIG. 3.

First, the merchant logs on using its unique login and secure password (block 310) as created in the merchant registration process (FIG. 2). Next, the merchant submits information about the promotion such as the name of the promotion, the category of goods or services in which the promotion falls (e.g., sports, lodging, food, entertainment, airline etc.), the points available, the dates that the promotion is effective, the location of the promotion event, any specific restrictions, and other information relating to the promotion (block 320). Third, the merchant may submit any additional files such as graphic files, sound files, or other files associated with the display of the promotion (block 330). Finally, the merchant may submit another promotion (block 340) or log off the system (block 350).

FIG. 3 illustrates one embodiment of a promotion collection process and other embodiments may be used. For example, a merchant may submit or be assigned a unique identifier for each promotion. Further, the attachments may be submitted at a different time.

It is recognized that in other embodiments, the merchant may submit information about the promotion using other methods of submission such as by email, filling out a paper questionnaire, faxing the information, microwave etc.

3. Merchant Billing Process

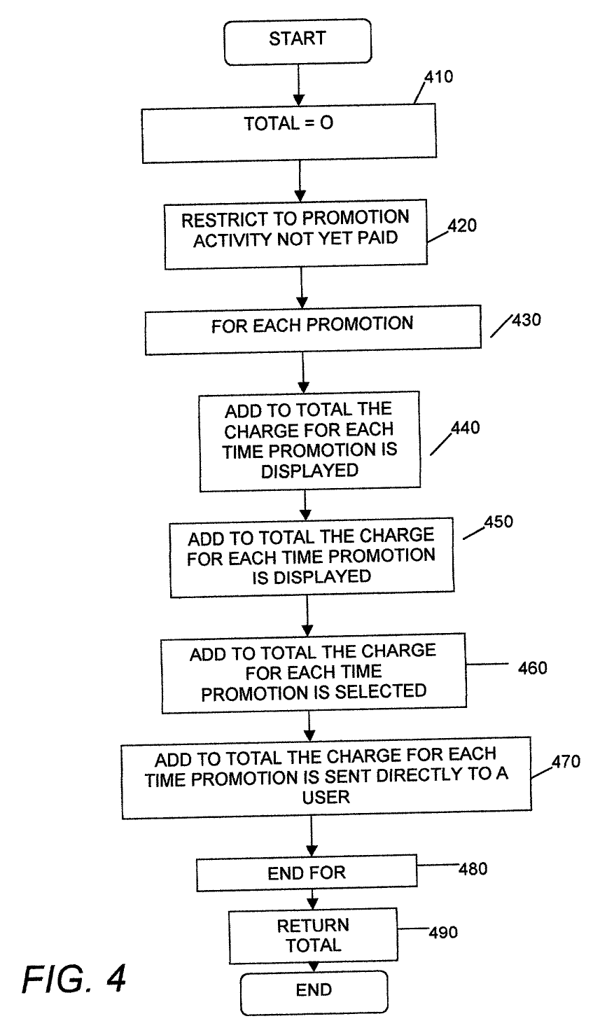

In accordance with one embodiment of the invention, the merchant billing process tracks when merchant's promotions are displayed or sent directly to the user. In one embodiment, the merchant is billed for any activity in which the merchant's promotion is used by the system as illustrated in FIG. 4.

First, the total is initialized to zero (block 420). Next, the activity is restricted to activity for which the merchant has not yet paid (block 420) as to avoid duplicate billing. In other embodiments, the activity could be restricted to different activity (e.g., for activity not yet billed) or not restricted at all. Then, for each of the merchant's promotions (block 430), the merchant is charged for every time (i): the merchant adds a promotion to the system (block 440), (ii) one of the merchant's promotions is displayed on the web page as a direct advertisement or on the calendar transaction manager agent (block 450), (iii) a user selects one of the merchant's promotions (block 460), (iv) one of the merchant's promotions is sent directly to a user (block 470), and any other time a merchant's promotion is used. After all of the merchant's promotions have been traversed (block 480), the total is returned (block 490).

It is recognized that the merchant billing process may be implemented in a different manner. For example, a running total may be stored in the database and incrementally updated with user activities every time a user accesses a merchant's site; every hour, every day, upon merchant request, and so forth.

In other embodiments, different factors as well as any subset and/or combination of those described above may be considered when billing the merchant. In addition, certain activity may be weighed more heavily than other activity. For example, a merchant may be charged more for each time a user selects its promotion and less for each time a promotion is merely displayed in the transaction manager. In addition, a merchant may receive a discount for submitting multiple promotions. The merchant billing process is preferably run for each merchant in the system. In an alternative embodiment, a fee could be charged for posting a promotion with no fees for display or use.

In one embodiment, merchants may log onto the system and view their current billing information. In addition, merchants may view their billing information by activity pertaining to a subset of users, an individual promotion, a subset of promotions, or all of its promotions. In addition, the merchant can limit the usage and the number of times the promotion can be selected by users. The merchant billing process may calculate each merchant's bill on a regular basis or dynamically each time the merchant wishes to view its current bill.

B. User Customization Module Processes

In one embodiment, the user customization module 154 includes a user registration process and user request process. The user customization module 154 may include other processes (not shown) such as, for example, a process for sending updates to users, a process for tracking user activity, and so forth.

1. User Registration Process

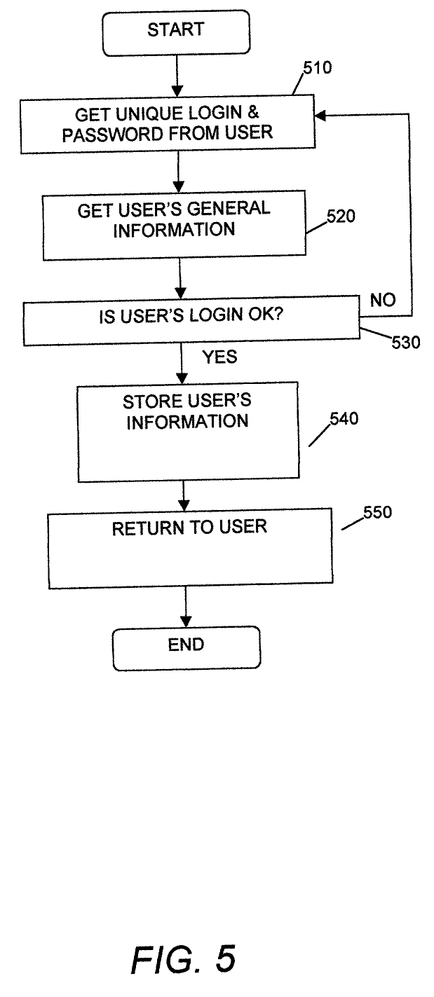

In accordance with one aspect of the invention, the user registration process collects and manages information about the users that wish to use a calendar transaction manager. The user registration process may permit users to designate their interest on-line via the web site as illustrated in FIG. 5.

First, the user may create a unique login and secure password (block 510). Next, the user may submit general information such as the user's name, mailing address, state, zip code, phone number, email address, gender, age as well as any other general information (block 520). Then, the user registration process verifies that the login is unique (block 530), stores the user's information (block 540), and returns to the user (block 550).

It is recognized that in other embodiments, the user may submit information using other methods such as submission by email, filling out a paper questionnaire, faxing the information, etc. In addition, in other embodiments, the user may choose to bypass the login process.

2. User Request Process

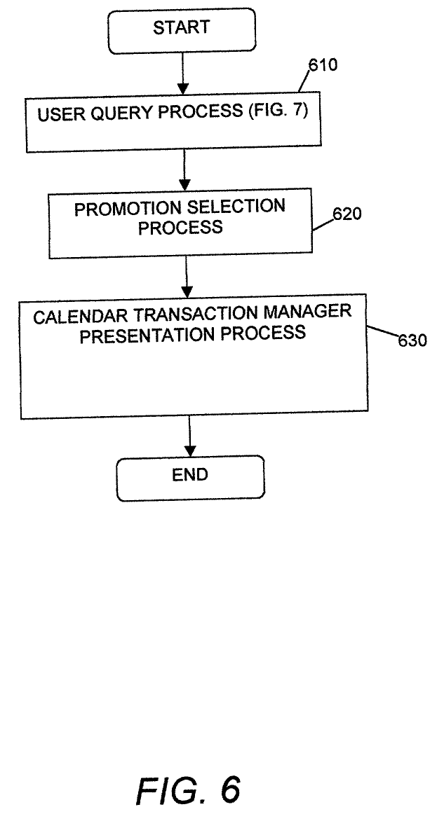

In accordance with one aspect of the invention, the user request process presents the user with a custom calendar transaction manager and permits the user to indicate whether merchants may access the user transaction manager and requests. For example, a user may allow merchants to “bid” on the user's request. Preferably, as illustrated in FIG. 6, the user request process contains a user query process (block 610), a promotion selection process (block 620), and a calendar transaction manager presentation process (block 630).

### a. User Query Process

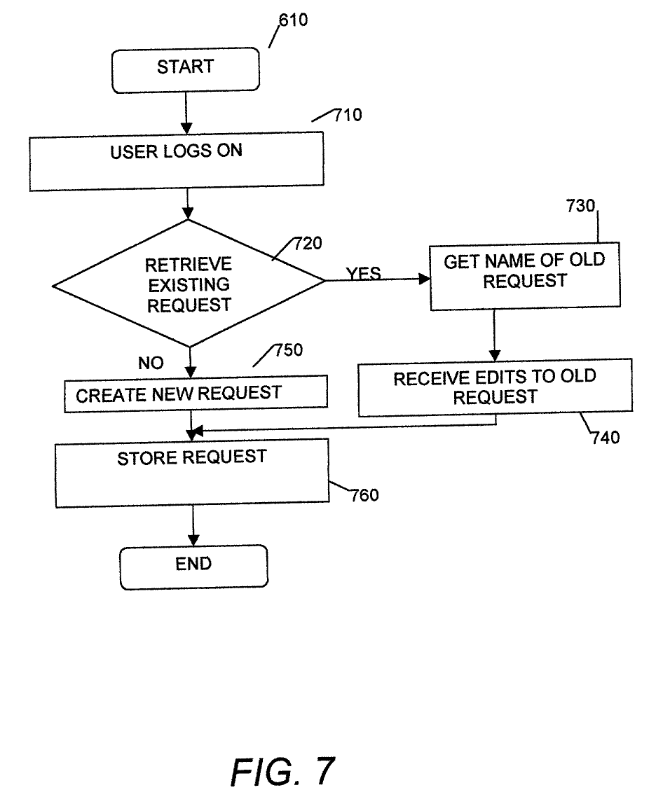

In one embodiment, the user query process queries the user to determine the user's interests as illustrated in FIG. 7. First, the user logs on using the unique login and secure password (block 710) as created in the user registration process (FIG. 5). It is recognized that in other embodiments, however, that the user may bypass the login. Next, the user may choose to create a new request or to retrieve and existing request (block 720). If the user retrieves an old request, then the user may enter the name or ID of the existing request (block 730) and edit the retrieved request (block 740) through edits such as altering the name, category, place, fate, and/or event. For example, if the user has indicated that merchants may access the user's requests, merchants may have added promotions to the promotions database which will now appear on the user's calendar transaction manager. Users may also, if requested by the user, receive email from merchants who view the user's transaction manager and want to provide a promotion. It is recognized that in other embodiments, the request may be defined by parameters other than or in addition to name, category, date, place and event. For example, the request may include price range, number of persons, preferred hotel, quality ratings (e.g., four stars), number of loyalty points, etc.

If the user chooses to create a new request, then the user may create a new request by entering a name for the request and then designating the category, place, date and desired event (block 750). The user preferably submits information via a set of blank fields, through other interface techniques or combinations thereof could be used such as radio buttons, checkboxes, drop down lists, etc. Finally, the process stores the results in the database collection 160 (block 760). In one embodiment, the user may elect to receive email when a relevant new promotion is added to the promotion database.

### b. Promotion Selection Process

In one embodiment, the promotion selection process chooses promotions related to the user's designated interests. The promotion selection process may select promotions specific to the user's request (e.g., interest rate, pay off date, loyalty points, category, place, date, and/or event) that may be displayed in the calendar transaction manager as well as promotions that relate, in general, to the user's interests. For example, if the user indicated an interest in “Golfing in Maui during the month of June 1999,” the promotion selection process may select a promotion for “50% off all green fees at the Maui Golf Course from June 6^{th} to June 12^{th}” as well as a coupon for “Free golf balls with every purchase” if the user purchases using a specific credit card.

It is recognized that the promotion selection process may be implemented differently in other embodiments.

### c. Calendar Transaction Manager Presentation Process

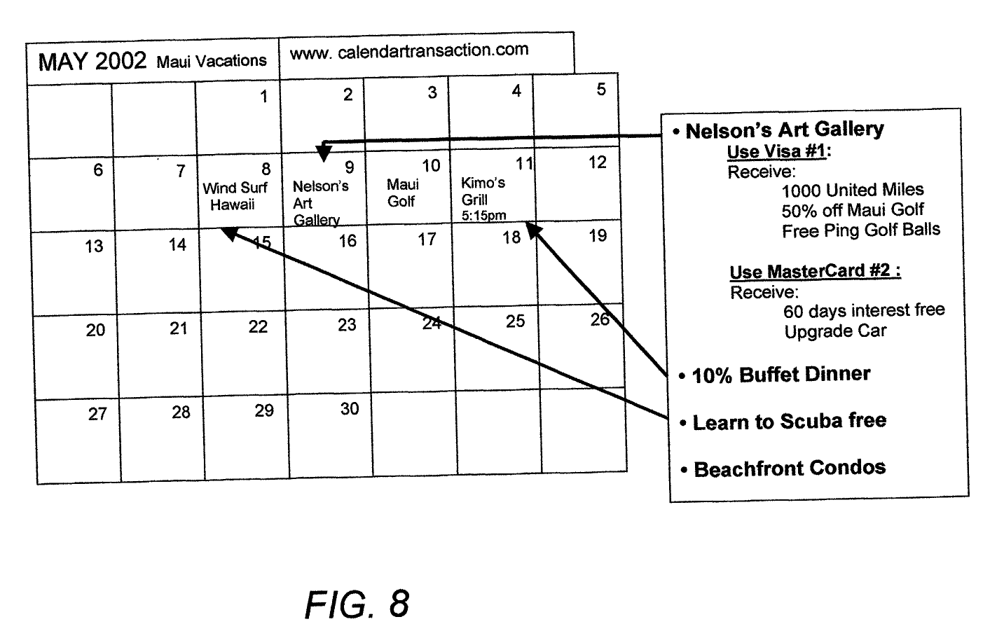

In one embodiment, the calendar transaction manager presentation process displays promotions relating to the user's designated interests in a transaction manager format. For example, in each calendar transaction manager credit account, a symbol or hyperlink may be shown such that the user can select the symbol or hyperlink and receive more detailed description of the available promotions. It is recognized that in other embodiments, the placement of the promotions or a link to the promotions on the transaction manager may be different such as a check box, a pop-up window, or other graphical interface feature. FIG. 8 illustrates a sample calendar transaction manager web page.

In one embodiment, the promotions may be color coded or emphasized using different fonts an/or various graphics to allow the use to differentiate between merchants or to identify rankings of features such as price, date, time or place.

In one embodiment, users and/or merchants may communicate with the calendar transaction manager using standard interface techniques, such as, for example, a mouse, a touch screen, voice commands, a keyboard, a pen, and so forth. In addition, various commands may be available to the user and/or merchant through a variety of interface tools. For example, the user may be able to click on a promotion and be automatically connected to the merchant (e.g., via the merchant's web site, email, or telephone) to confirm information about the promotion; a merchant may be able to click on a button that allows the merchant to look at the merchant's transaction manager of promotions, billing information, as well as other information.

Furthermore, it is recognized that the calendar transaction manager may be implemented in a variety of languages as well as using a variety of transaction manager methodologies.

In one embodiment, the calendar transaction manager presentation process displays promotions related to the user's designated interests in a single promotion format. For example, the calendar transaction manager presentation process may send the user an interactive coupon for “15% off scuba equipment rental” with a link to the scuba company's web site in association with the use of a specific credit card. In another embodiment, the calendar transaction manager presentation process displays a set of promotions related to the user's designated interest The set of promotions may include a set of promotions related to Golf in one page under a tab marked “GOLF” and a set of coupons related to various restaurants in another page under a tab marked “DINING.” The calendar transaction manager presentation process may also display on one page a list of links to coupons related to Golf and a list of links to coupons related to Dining. Furthermore, the user may be presented promotions to the user through a variety of methods such as direct targeting of individual users or groups of users, that is users who have similar interests. This targeting may include promotions sent via email, promotions sent to a cellular phone, promotions sent to a personal digital assistant display, and so forth.

IV. Operation

In operation, the calendar transaction manager system may be used to provide merchants with the ability to market their dynamically changing inventory of goods and services. In addition, users can designate goods and services of which they have an interest and be presented with promotions that match those interests.

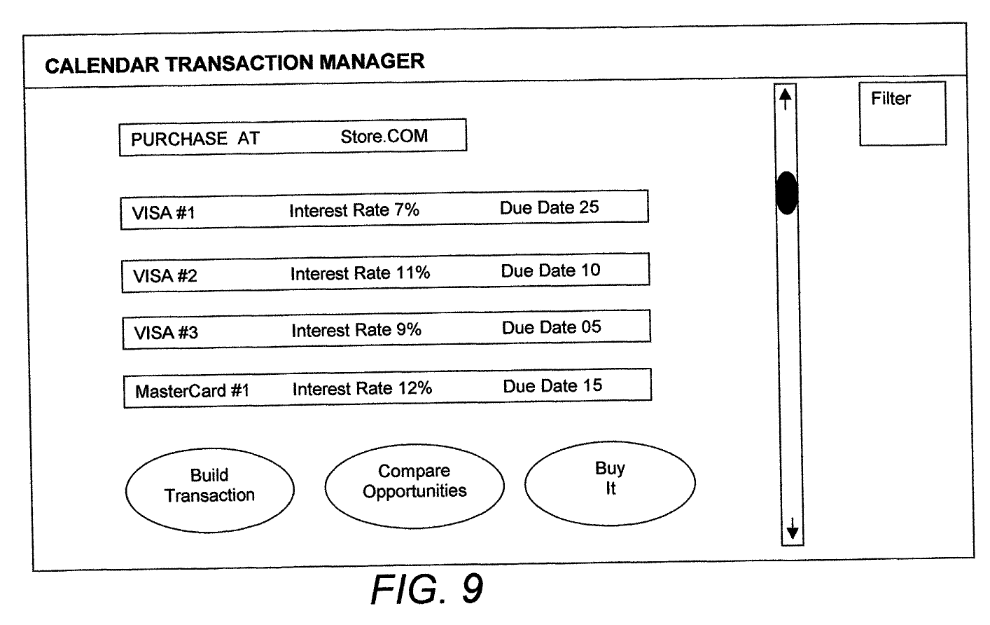

For example, a user may be planning to travel to Maui, Hawaii from May 6, 2002 to May 12, 2002 and is interested in promotions that pertain to car rental, scuba diving, wind surfing, dining, shopping, and/or tennis. Thus, the user may contact the calendar transaction manager system using, for example, his cellular phone and request information using voice commands on the above areas specifying the dates of his travel. The system may then present the user with a display of the week of travel as well as promotions that match his interest. FIG. 9 illustrates a sample display that includes promotions for Golf, Scuba, Dining, Car rental, and Tennis for the dates of May 6 to May 12.

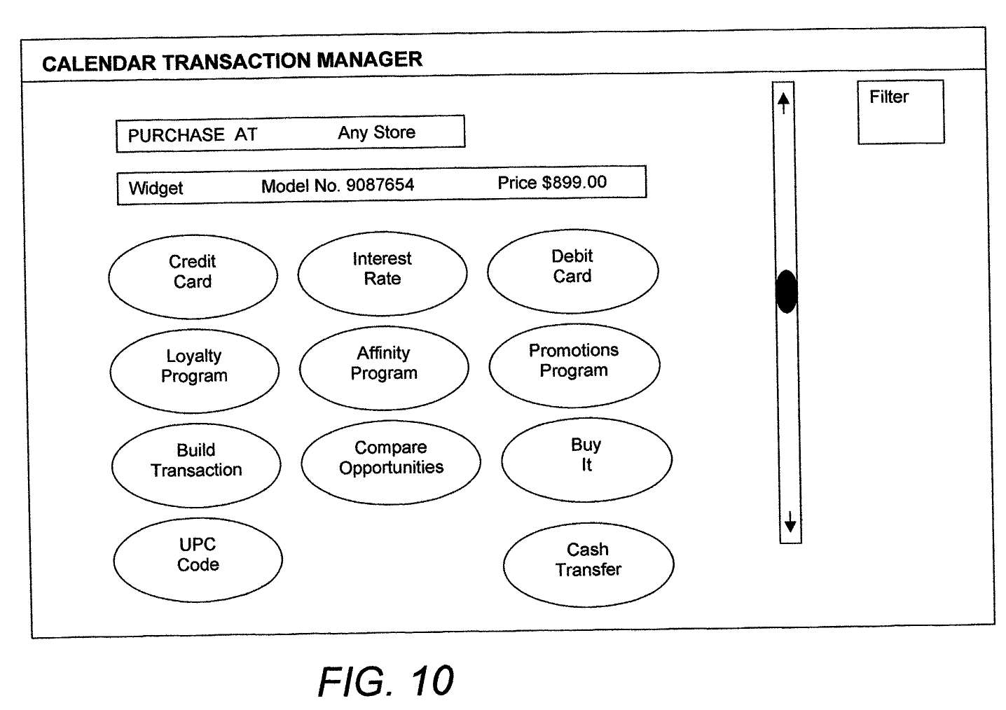

The filter depicted in FIGS. 9 and 10 provides differential filters that enable the user to restrict the types of offers provided in the system in a variety of ways such as finely defining the precise requirements of the good or service desired by the user. In essence, the filter option permits the user to filter unwanted offers that do not match the user's exact requirements. Filter attributes may be configured to include and/or exclude almost anything a user desires.

For example, the user may have four credit lines each with different due dates when the bill must be paid in full. The user sets the customization module to execute the purchase transaction on the credit line with the most number of days prior to the account being due and payable. FIG. 9 illustrates a way in which users and/or purchasers may manage various credit cards used in a storefront. Perhaps the store (e.g. Albertsons) is co-promoting with MasterCard or with a particular bank entity. The purchaser may reveal to the storefront various account information. Albertsons may then suggest MasterCard #1 as a payment method to save money and earn additional opportunities (e.g., the filter reveals that the purchaser may collect United Airline Miles). However, the purchaser may want to compare opportunities, build a transaction (e.g., using various UPCs from purchased Pepsi and Heinz 57 products), and finally buy the product and service. The purchaser has the capability of analyzing elements that may affect the transaction. Moreover, the filter switch enables the purchaser access to his or her preferences.

The electronic device, where the user's calendar transaction manager resides, presents the information on the credit lines prior to the purchase transaction through a visual display or by audible information to the user and/or the system could be set to automatically default to the desired preferences of the user and execute the transaction automatically. In this respect, the calendar transaction manger module 150 may operate independently as an agent on behalf of the user.

FIG. 10 displays various elements that may affect the transaction's actual cost. For example, the calendar transaction manager may suggest Visa #1 because of the long billing cycle or interest rate which was established by the user when creating his or her “rules”. The user may override the system and manually compare other possibilities, such as, for example, co-promotions against the UPC of a product, air miles and so forth.

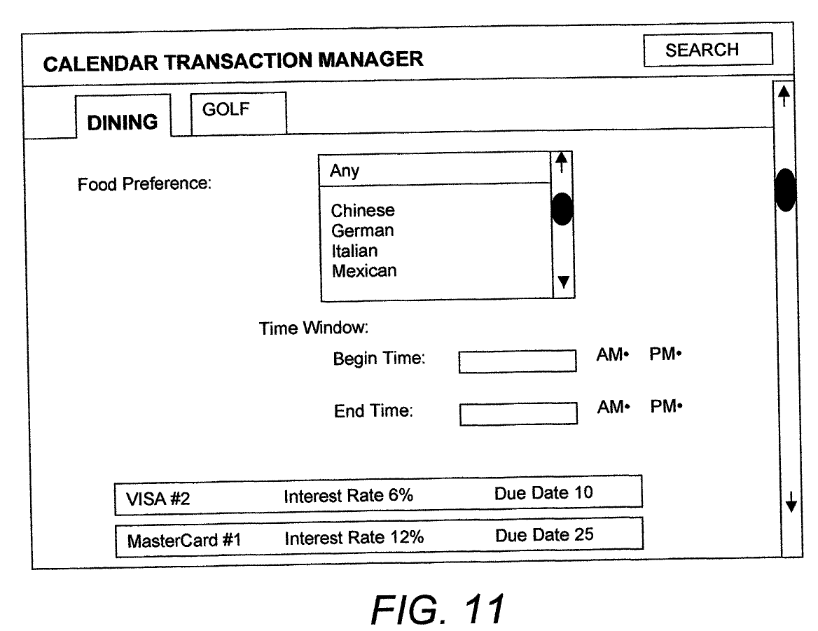

Suppose the user is interested in finding out more information on the dining promotions, the user may select dining using a voice command and the user may be presented with a list of options that pertain to dining as illustrated in FIG. 11. By selecting Food Preference, the user may select from a variety of food features such as, for example, Chinese, Mexican, Italian, German, Vegetarian, Unsalted, Kosher, Organic, No Preservatives, No MSG, and so forth. In addition, the user may elect a specific time window such as, for example, 6:00 am, 12:00 noon, or 5:30 pm. Furthermore, the user may also select a preferred locations feature, such as, for example, Lahaina, Kihei, Al's Grill, The Steak House, Seafood Station, No Smoking, Smoking, Window, Near a specific address location (enter address), and so forth. Finally, the user may want to compare the opportunities based on the specific credit card that he will use in the purchasing (transaction) process.

The user may also utilize a map feature that presents the user with a map of the location of the service as well as other information. This information may include driving distance, Time distance, photo of location, photo of building, sample menu, list of prices, and so forth.

After the user has selected his preferences, if any, the user may also purchase the merchant's goods and/or services. For example, if the user selects a 10% discount for a full buffet dinner at 5:30 pm on May 8, for a no smoking table at Lelani's, the user may then elect to pre-purchase the dinner. The user will then pay for the goods/services with the digital wallet feature contained within the calendar transaction manager using an electronic account, a credit card, a debit card, an ATM card, a direct debit code, loyalty/affinity points and so forth.

In another example, a user may be planning a business party in Portland, Oreg. on Jun. 4, 2000 and may be looking for a caterer for the party. The user may contact the calendar transaction manager system using, for example, his Palm Pilot and request information about caterers in Portland, Oreg. on Jun. 4, 2002 and present the user with a set of promotions from various merchants. One merchant may for example, offer a 20% discount for parties of 400 or more, 10,000 airline mileage points, with the use of a specific credit card in an interactive coupon that includes a web link to the merchant's web site and airline's site. Another promotion may include a video and audio commercial that runs on the user's Palm Pilot and that illustrates sample entrees in which the caterer specializes and may include a voice activated command at the end of the commercial that sends an email directly to the caterer with the user's email address and other contact information.

Finally, although a sample calendar transaction manager display has been shown above, the display of a calendar transaction manager is not necessary. Specifically, the calendar transaction manager promotion system may provide a simple agent service. In one embodiment, rather than a calendar transaction manager display, a user merely inputs the desired activity or purchase and the date desired through entry fields, or through a promotion presentation screen, or through a voice response. In this embodiment, the actual calendar transaction manager grid is not required. In other words, in an embodiment without the calendar transaction manager grid, the calendar transaction manager system operates as an agent for the user with the user inputting the desired activity, location and date, and the calendar transaction manager system providing or allowing merchants and service providers to provide options directly to the user with a presentation window rather than the transaction manager grid. Accordingly, the present invention is not limited to the use of a transaction manager grid interface. Voice and other presentation interfaces may provide the same matching of offers for goods and services with desired dates for such goods or services of the user.

V. Additional Embodiments

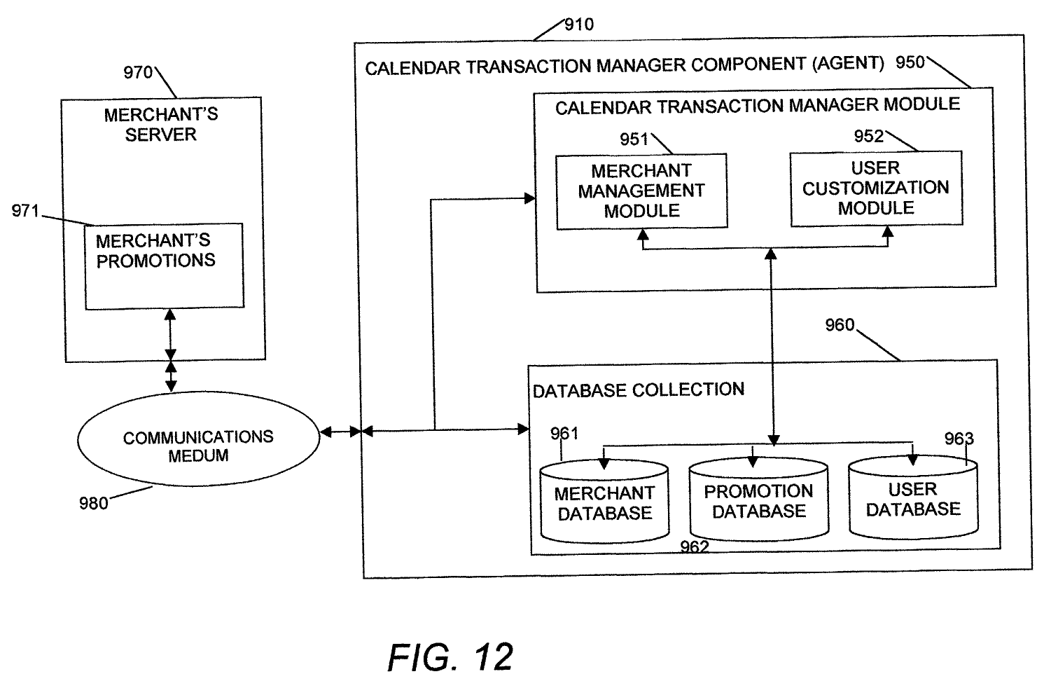

In other embodiments, the calendar transaction manager 910 may operate as a standalone agent as shown in FIG. 12. that the calendar transaction manager as described previously. The agent 910 may be embedded in a variety of devices or could be transmitted as an application, such as a JAVA Applet (application) through the communications medium 130. The calendar transaction manager component 910, illustrated in FIG. 12 includes a calendar transaction manager module 950, and a database collection 960.

The calendar transaction manager component 910 may interact with other components, interfaces, and/or protocols (not shown). For example, the calendar transaction manager component 910 may communicate with a merchant's promotions database in order to synchronize with other promotions which are available based on the use of credit cards, debit cards, ATM, loyalty points, affinity points or discounts. This synchronization may be one way or two way synchronization wherein the calendar transaction manager module 950 only receives events, only sends events, or receives and sends events. In another example, the calendar transaction manager may synchronize with a cellular phone to allow the user to receive phone calls about a variety of promotions and/or to automatically call merchants to obtain more information about the promotions. In another example, the calendar transaction manager might be set to acquire discounts in a certain location, i.e. zip code. The user might activate a GPS (global positioning) interface for the calendar transaction manager to send opportunities which match the user's interest in a specific location. By restricting selections, the calendar transaction manager may also become a filter preventing invasion of the user's privacy by unwanted advertisers.

In one embodiment, the customer may play a game via a rules-based module or the calendar transaction manager. For example, as part of a travel package, the customer may be invited to participate in a game through merchants in Maui. Manufacturers co-promote through the customer's personal calendar transaction manager and may apply new “rules” to drive traffic through stores on particular dates or at particular times to increase purchasing. A travel agent may ask ask the customer how the customer wants to play the game (i.e. what are your rules?) The customer may reply, “through my cell phone, use SIC codes for the stores and UPC's for the products”. The travel agent may respond, “if you confirm every SIC code through your calendar transaction manager, we will give you 10,000 air miles or $50.00 to spend loaded into your credit account at completion.” In other examples, the customer may be competing with other customers to “win the game” and to thus win various promotions.

Another aspect of the present invention involves the ability of the calendar transaction manager module as an agent communicating with another calendar transaction manager module/s to coordinate opportunities. In one example, a customer (#1) has a digital device which is embedded with the calendar transaction manager module. Another customer (#2), in close proximity, also has a digital device embedded with the calendar transaction manager module (agent). Customer (#1) might desire to update the promotions and or loyalty point opportunities from customer (#2) who has just been on a communication network. By exchanging the information between devices either by a port (infrared, plug, etc.), keypad entry or voice, customer (#1) would be able to have current opportunities which customer (#2) had already updated without obtaining access to a network communication system such as telephone, microwave or Internet.

In one embodiment of the present invention involves a method for providing wire transfers of currency either within one country and/or from country to country. The method involves drawing on currency reserves and/or credit reserves which originate in one country and using arbitrage calculations similar to banks to maximize the final amount of currency available when transferred to another location within the originating country or another country. In one embodiment, the user customization module is further configured to make a series of currency exchanges between a plurality of countries to insure that the greatest amount of currency is made available at the final country for which the original currency transfer was destined.

Another aspect of the present invention involves a method for making electronic payments on a variety of credit/merchant accounts based on predetermined preferences. In one embodiment, the user customization module is configured to automatically execute payments to merchants at specific time periods. In a further embodiment, the user customization module is further configured to automatically notify the user of payment due dates and account status through a communication medium including but not limited to email and/or voicemail.

Another aspect of the present invention involves a unified billing system so that payments for accounts established can be executed either by manual configuration of the calendar transaction manager by the user or automatically by the calendar transaction manager as configured by the user's preferences. In one embodiment, the calendar transaction manager could combine all the available opportunities including credit, debit, loyalty points and promotions to effect payment to a specified account. The unified billing system could also include an alert payment notification which could be executed from a variety of communication systems including email, telephone and paging for example.

Yet another embodiment of the present invention involves a method of insuring user security when utilizing the calendar transaction manager through a variety of devices. In one embodiment, the user's device so embedded with the calendar transaction manager, requires a confirming biometrics message to begin transacting. The biometrics message might be recognized by a portion of the user's device so enabled to recognize DNA, thumb print, voice and/or eye (iris print). Additionally, another embodiment would require a numeric protocol to activate the calendar transaction manager.

Another aspect of the present invention involves a method for providing custom promotions based on the dates and/or times that the purchase transaction occurs.

Another embodiment of the present invention involves a method for providing custom promotions based on location..

Another aspect of the present invention involves a method for providing custom promotions based on the credit and/or debit account being used for the purchase transaction.

Another aspect of the present invention involves a method for providing custom promotions based on the credit worthiness or rating of the user's account status being used for the purchase transaction.

Another embodiment of the present invention involves a method for providing custom promotions based on the loyalty and/or affinity points programs being used for the purchase transaction.

Another embodiment of the present invention involves a method for providing automatic synchronization for the transaction based on the credit account, debit account, loyalty and/or affinity points programs being used for the purchase transaction.

Another embodiment of the present invention involves a method for providing custom promotions based on the point of purchase for the purchase transaction.

Another embodiment of the present invention involves a method for providing custom promotions based on the UPC Code (Uniform Price Code) prior to the purchase transaction. The UPC Code of the product could be input through the user's device by keypad, voice or scanning receiver. Concurrently, the manufacturer of the subject product or storefront where the product is located could interface with the user's calendar transaction manager to provide additional opportunities to induce a particular purchasing method.

Another embodiment of the present invention involves a method for providing merchants the opportunity to bid for the credit relationship with the user at the time of or prior to the purchase transaction or in an open bidding process to develop a merchant credit relationship with the user.

Another embodiment of the present invention involves a calendar transaction manager agent which has a user customization module configured by the user to automatically execute purchases based on predetermined preferences. In this embodiment, the user customization module is configured to process purchase transactions based on the user's desire to have a specified number of days before the account is due, a specified interest rate and/or specified loyalty points available as a promotion from a merchant. In a further embodiment, the user customization module is further configured to present the purchasing options to the user prior to executing the purchase transaction. For example, the user may have four credit lines each with different due dates when the bill must be paid in full. The user sets the customization module to execute the purchase transaction on the credit line with the most number of days prior to the account being due and payable. The electronic device, where the user's calendar transaction manager resides, presents the information on the credit lines prior to the purchase transaction through a visual display or by audible information to the user and/or the system could be set to automatically default to the desired preferences of the user and execute the purchase transaction automatically. Another example might include the information being transmitted as an Applet (application) through a communication medium and merchants having the ability to interface with the transaction manager agent to present opportunities and transmit them back to the location of the user or his device. In this aspect the calendar transaction manager module operates independently as an agent on behalf of the user.

VI. Conclusion

While certain embodiments of the invention have been described, these embodiments have been presented by way of example only, and are not intended to limit the scope of the present invention. Other embodiments that are apparent to those of ordinary skill in the art are also within the scope of this invention. For example, although the embodiments described herein employ on-line registration, other methods for registration can be used. Accordingly, the breadth and scope of the present invention should be defined in accordance with the following claims and their equivalents.

What is claimed is:

1. A system for facilitating the matching of at least one promotion with at least one user, the system comprising:
a merchant management module configured to manage at least one promotion that corresponds to at least one of a plurality of merchants;
a user module configured to mange preferences; and
a calendar transaction module configured to present information about the at least one promotion to one the at least one user wherein the promotion relates to preferences that correspond to the user.

2. The system of claim 1, wherein the merchant module is further configured to:
register a plurality of merchants;
collect promotion program information; and
track merchant billing information.

3. The system of claim 1, wherein the user module is further configured to:
process a user query to determine user interest;
select promotions that relate to the user interest; and
present an electronic document that includes information about the selected promotions.

4. The system of claim 3, wherein the user module is further configured to process purchase transaction information relating to at least one of the selected transactions.

5. The system of claim 1, wherein the user module is configured to register a plurality of users.

6. The system of claim 1, wherein the user module is configured to present the user with access to a user calendar transaction manager tool, wherein the user calendar transaction manager tool is configured to:
process a user query to determine user interest,
select promotions that relate to the user interest; and
present an electronic document that includes information about the selected promotions.

7. A method for managing promotions, the method comprising:
receiving a plurality of promotions relating to a plurality of merchants;
receiving user information relating to a plurality of users;
matching at least one of the plurality of promotions to at least one of the plurality of users based upon a portion of the plurality of user information; and
presenting to the at least one of the plurality of users information in a promotion document about the at least one of the plurality of promotions.

8. The method of claim 7, wherein the promotion document includes an interactive coupon.

9. The method of claim 7, wherein the promotion document includes an advertisement audio and video commercial.

10. The method of claim 7, wherein the user information includes at least one of a designated activity, a designated location, a range of dates, a desired good and a desired service.

11. A method of managing a plurality of custom-selected promotions, the method comprising:
requesting a plurality of promotions relating to a plurality of merchants;
submitting user information relating to at least one user;
receiving a set of promotions, wherein the set corresponds to at least a subset of the user information and at least one of the plurality of merchants; and
selecting at least one of the set of promotions.

12. The method of claim 11, wherein the set of promotions are presented in an electronic document, wherein the electronic document includes at least one of text, audio, graphics, and video data.

13. The method of claim 11, wherein the user information includes at least one of a designated activity, a designated location, a range of dates, a desired good and a desired service.
